(19) United States
(12) Patent Application Publication
(10) Pub. No.: US 2021/0357809 A1
(43) Pub. Date: Nov. 18, 2021

(54) MODEL IMPROVEMENT SYSTEM AND MODEL IMPROVEMENT METHOD

(71) Applicant: HITACHI, LTD., Tokyo (JP)

(72) Inventors: Kyosuke HASHIMOTO, Tokyo (JP); Soichi TAKASHIGE, Tokyo (JP)

(21) Appl. No.: 17/191,813

(22) Filed: Mar. 4, 2021

(30) Foreign Application Priority Data
May 14, 2020 (JP) 2020-084959

(51) Int. Cl. G06N 20/00; G06K 9/62

(52) U.S. Cl. CPC G06N 20/00; G06K 9/6262; G06K 9/6261; G06K 9/6228

(57) ABSTRACT

To efficiently and appropriately improve an inference model when the inference model outputs an inappropriate inference result that affects work. A model improvement system performs inference related to the work using an inference model which is a machine learning model that outputs an inference result by inputting an input matrix, acquires an actual result which is information acquired by actually performing work to be inferred by the inference model, determines whether or not the inference result is an inappropriate content that affects the work by comparing the inference result with the actual result, divides a part of the input matrix that outputs the inference result that affects the work from the input matrix, and generates an inference model that outputs an inference result that does not affect the work when the part divided from the input matrix is input as an input matrix.

### CROSS-REFERENCE TO RELATED APPLICATION

This application claims priority pursuant to Japanese patent application No. 2020-084959, filed on May 14, 2020, the entire disclosure of which is incorporated herein by reference.

### BACKGROUND

### Technical Field

The present invention relates to a model improvement system and a model improvement method.

### Related Art

JP-A-2019-79392 (Patent Literature 1) describes a learning device that performs machine learning using learning data to automatically build a prediction model for a class classification problem of predicting a label of input data. The learning device is a pipeline that combines a plurality of processings performed when building the prediction model that predicts the label of the input data. A plurality of different pipelines are generated according to setting information of each processing. Among models in which models representing the generated pipelines are weighted and combined, a model having highest prediction accuracy is searched as the prediction model.

T. Chen, et al. “XGBoost: A Scalable Tree Boosting System”, KDD '16: Proceedings of the 22nd ACM SIGKDD International Conference on Knowledge Discovery and Data Mining. August 2016. Pages 785-794. https://doi.org/10.1145/2939672.2939785 (Non-Patent Literature 1) discloses a technique of building a new decision tree by using existing features as input and using a difference (error) between an inference result of a decision tree and a correct answer as an objective variable, and using the new decision tree in combination.

In recent years, a machine learning model (hereinafter referred to as “an inference model”) is used in various work fields, and various users such as IT engineers, data scientists, and site workers use an inference result of the inference model to do work at work sites.

However, the inference model has a characteristic of performing learning at any time using the limited learning data that can be acquired. Therefore, the inference model does not always output a complete inference result, and sometimes may output an inappropriate inference result that affects the work. Here, in the related art, since work evaluation is performed according to a rule established by people, for example, when a result of work evaluation does not satisfy a key performance indicator (KPI), it is possible for people to identify a cause thereof and take appropriate measures. However, the inference model is usually implemented by a complex algorithm, and according to the characteristic thereof, it is not always easy to identify a basis of the inference result, and it is difficult to improve the inference model so as not to output the inappropriate inference result that affects the work.

Both Patent Literature 1 and Non-Patent Literature 1 relate to a technique of synthesizing an inference result of an inference model (the prediction model or the decision tree). A sub-model newly generated by these techniques can also affect the input data in a range where the original inference model can obtain the inappropriate inference result that affects the work. Therefore, after generating the new sub-model, the user is required to verify that a service level agreement (SLA) is not compromised, which requires a great deal of labor and cost.

### SUMMARY

The invention is made under such a background and for a purpose of providing a model improvement system and a model improvement method that can efficiently and appropriately improve an inference model when the inference model outputs an inappropriate inference result that affects the work.

One aspect of the invention for achieving the above purpose is a model improvement system implemented by an information processing device, the model improvement system comprising a model application unit configured to perform inference related to work using an inference model which is a machine learning model that outputs an inference result by inputting an input matrix, an actual result acquisition unit configured to acquire an actual result which is information acquired by actually performing work to be inferred by the inference model, a work impact determination unit configured to determine whether or not the inference result includes an inappropriate content that affects the work by comparing the inference result with the actual result, an input matrix division unit configured to divide a part of the input matrix that outputs the inference result that affects the work from the input matrix, and a model rebuilding unit configured to generate an inference model that outputs an inference result that does not affect the work when the part divided from the input matrix is input as an input matrix.

Other problems disclosed by the present application and methods for solving such problems will be clarified by descriptions in embodiments and drawings.

According to the invention, it is possible to efficiently and appropriately improve the inference model when the inference model outputs the inappropriate inference result that affects the work.

### BRIEF DESCRIPTION OF THE DRAWINGS

FIG. 1 is a diagram showing main functions of a model improvement system;

FIG. 2 is a diagram showing a hardware configuration example of an information processing device used to implement the model improvement system;

FIG. 3 is a diagram showing an example of an input matrix table;

FIG. 4 is a diagram showing an example of a work impact management table;

FIG. 5 is a diagram showing an example of a model management table;

FIG. 6 is a diagram showing an example of an algorithm table;

FIG. 7 is a flowchart illustrating model improvement processing;

FIG. 8 is a sequence diagram illustrating the model improvement processing;

FIG. 9 is a flowchart illustrating details of work impact determination processing;

FIG. 10 is a diagram showing an example of a source code of a program that implements processing of determining impact of an inference result on work;

FIG. 11 is a flowchart illustrating details of input matrix division processing;

FIG. 12 is a flowchart illustrating details of inference model rebuilding processing;

FIG. 13 is a diagram showing an example of a work impact presentation screen;

FIG. 14 is a diagram showing an example of an input matrix division result presentation screen; and

FIG. 15 is a diagram showing an example of a model rebuilding possibility information presentation screen.

### DESCRIPTION OF EMBODIMENTS

Hereinafter, an embodiment will be described in detail with reference to the drawings. In configurations of the invention described below, the same reference numeral is used in common among different drawings for the same part or parts having the same function, and duplicate description is omitted. When there are a plurality of elements having the same or similar functions, the elements may be described by adding different additional characters to the same reference numeral. However, when it is not necessary to distinguish the plurality of elements, the elements may be described by omitting the additional characters. In the following description, a letter in front of the reference numerals means a processing step.

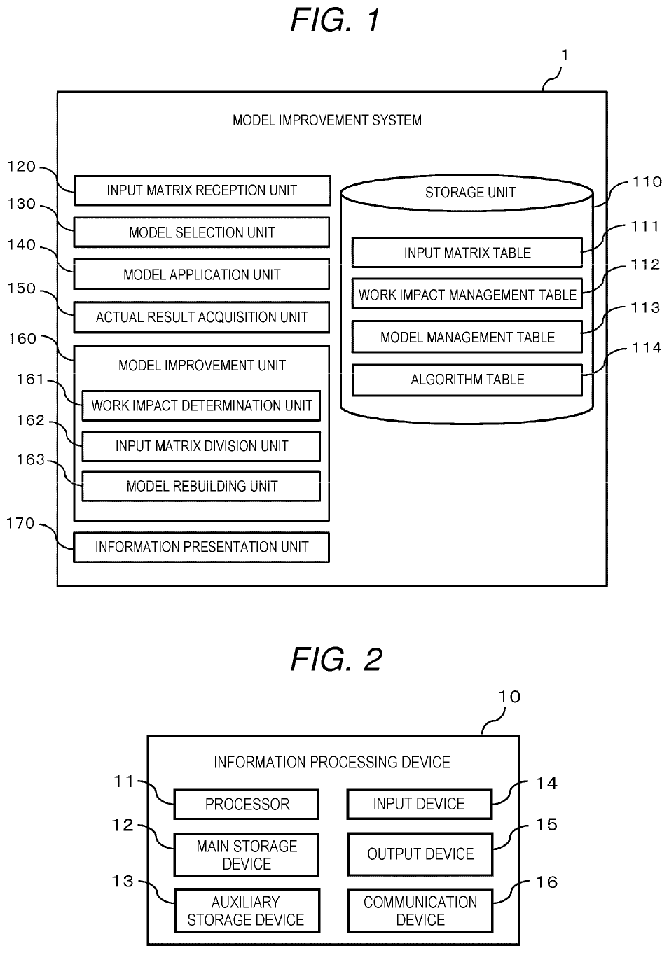

FIG. 1 shows main functions of an information processing system (hereafter referred to as “model improvement system 1”) described as one embodiment. When a machine learning model (hereafter referred to as “inference model”) that performs inference about an indicator related to work outputs an inappropriate inference result that affects the work, which is performed using inference results of the inference model about input data (hereafter referred to as “input matrix”), the model improvement system 1 improves the inference model so as to output an appropriate inference result about the input matrix. Specifically, the model improvement system 1 newly generates an inference model that outputs the appropriate inference result by using the input matrix for which the inappropriate inference result that affects the work is output as an input.

The inappropriate inference result that affects the work is for example, a case where information related to a work result obtained by actually performing the work that is a target of inference by the inference model (hereafter referred to as “actual result”) deviates from a key performance indicator (hereafter referred to as “KPI”). For example, the inference model is a model that outputs a time required for a vehicle to arrive at a destination in a vehicle allocation system as an inference result and as an indicator related to work. If an allowable arrival time upper limit of “7 minutes” is set as the KPI and the actual result is “10 minutes”, an inference result of “8 minutes” is the inappropriate inference result.

The model improvement system 1 newly generates the inference model by using the input matrix for which the inappropriate inference result that affects the work is output as a target when improving the inference model. Therefore, a current inference model can be applied to an input matrix for which an appropriate inference result is output, and it is possible to reduce load for verifying impact on a service level agreement (SLA) that a user (an IT engineer, a data scientist, a site worker, and the like) needs to perform when improving the inference model.

As shown in FIG. 1, the model improvement system 1 includes functions of a storage unit 110, an input matrix reception unit 120, a model selection unit 130, a model application unit 140, an actual result acquisition unit 150, a model improvement unit 160, and an information presentation unit 170. The storage unit 110 stores an input matrix table 111, a work impact management table 112, a model management table 113, and an algorithm table 114. The model improvement unit 160 includes functions of a work impact determination unit 161, an input matrix division unit 162, and a model rebuilding unit 163. The information presentation unit 170 presents various types of information to the user. The information presentation unit 170 generates, for example, screen definition data described in various languages such as Web page definition data, image data of a predetermined data type, and the like, and displays a work impact presentation screen 1300 and an input matrix division result presentation screen 1400, which will be described later.

FIG. 2 shows a hardware configuration example of an information processing device used to implement the model improvement system 1. As shown in FIG. 2, the illustrated information processing device 10 includes a processor 11, a main storage device 12, an auxiliary storage device 13, an input device 14, an output device 15, and a communication device 16. All or a part of the information processing device 10 may be implemented by using a virtual information processing resource provided using a virtualization technique, a process space division technique, or the like, as a virtual server provided by a cloud system, for example. All or a part of functions provided by the information processing device 10 may be implemented by, for example, a service provided by a cloud system via an application programming interface (API). The model improvement system may be configured to use a plurality of information processing devices 10 connected so as to be able to communicate with each other.

As shown in FIG. 2, the processor 11 is configured to use, for example, a central processing unit (CPU), a micro processing unit (MPU), a graphics processing unit (GPU), a field programmable gate array (FPGA), an application specific integrated circuit (ASIC), an artificial intelligence (AI) chip, and the like.

The main storage device 12 is a device that stores programs and data, and is, for example, a read only memory (ROM), a random access memory (RAM), a nonvolatile memory (NVRAM), and the like.

The auxiliary storage device 13 is, for example, a read and write device of a recording medium such as a solid state drive (SSD), a hard disc drive, an optical storage device (such as a compact disc (CD) and a digital versatile disc (DVD)), a storage system, an IC card, an SD card, an optical recording medium, and the like, or a storage domain of a cloud server. A program or data can be read into the auxiliary storage device 13 via a read device of a recording medium or the communication device 16. A program or data stored (memorized) in the auxiliary storage device 13 is read into the main storage device 12 at any time.

The input device 14 is an interface that receives input from outside, and is, for example, a keyboard, a mouse, a touch panel, a card reader, a pen input type tablet, a voice input device, and the like.

The output device 15 is an interface that outputs various kinds of information such as a processing process or a processing result. The output device 15 is, for example, a display device that visualizes the various kinds of information (such as a liquid crystal monitor, a liquid crystal display (LCD), and a graphic card), a device that vocalizes the various kinds of information (such as a sound output device (a speaker)), and a device that converts the various kinds of information into characters (such as a printing device). For example, the information processing device 10 may be configured to input information to other devices or output information from other devices via the communication device 16.

The input device 14 and the output device 15 configure a user interface that receives information from the user and presents information to the user.

The communication device 16 is a device that implements communication with other devices. The communication device 16 is a wired or wireless communication interface that implements communication with other devices via a communication network (the Internet, a local area network (LAN), a wide area network (WAN), a leased line, or a public communication network building), and is, for example, a network interface card (NIC), a wireless communication module, a USB module, and the like.

For example, an operating system, a file system, a database management system (DBMS) (relational database, NoSQL, and the like), a key-value store (KVS), and the like may be introduced to the information processing device 10. The functions included in the model improvement system 1 are implemented by the processor 11 reading and executing programs stored in the main storage device 12, or by hardware configuring the model improvement system 1 (such as an FPGA, an ASIC, or an AI chip). The model improvement system 1 stores the various kinds of information (data) as, for example, a database table or a file managed in a file system.

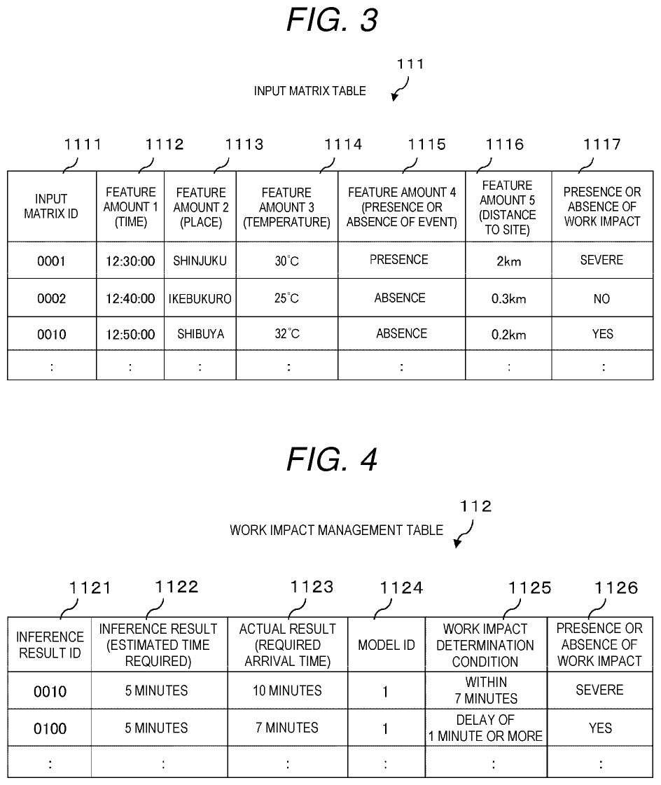

FIG. 3 shows an example of the input matrix table 111. The input matrix is managed in the input matrix table 111. The input matrix is input to the model improvement system 1 from user setting performed via the user interface, or from other information processing devices via communication or a recording medium. As will be described later, contents in the input matrix table 111 are updated at any time by the work impact determination unit 161. As shown in FIG. 3, the illustrated input matrix table 111 includes one or more entries (records) including each item of an input matrix ID 1111, feature amounts 1112 to 1116, and presence or absence of work impact 1117. Each entry of the input matrix table 111 corresponds to one input matrix.

In the input matrix ID 1111 among the items, an input matrix identifier (hereinafter referred to as “input matrix ID”) is set. In the feature amounts 1112 to 1116, feature amounts that are elements of the input matrix are set. For example, if the inference model is the model that estimates the time required for the vehicle to arrive at the destination in the vehicle allocation system, the feature amounts are, for example, “time”, “place”, “temperature”, “presence or absence of event”, “distance to site”, and the like. In this example, five feature amounts are illustrated, but the number of the feature amounts constituting the input matrix is not necessarily limited. The feature amounts may be set by the user via the user interface. In the presence or absence of work impact 1117, information indicating whether or not the inference result obtained by inputting the input matrix into the inference model is an inappropriate inference result that affects the work, and information indicating a degree of the impact on the work if the inference result is inappropriate are set. For example, in the presence or absence of work impact 1117, when the degree of the impact on the work of the inference result obtained by inputting the input matrix into the inference model exceeds a preset threshold, “SEVERE” is set; when the inference result affects the work but the degree thereof is less than or equal to the preset threshold, “YES” is set; and when there is not impact on the work, “NO” is set.

FIG. 4 shows an example of the work impact management table 112. Information and the like related to the inference result are managed in the work impact management table 112. As shown in FIG. 4, the illustrated work impact management table 112 includes one or more entries (records) including each item of an inference result ID 1121, an inference result 1122, an actual result 1123, a model ID 1124, a work impact determination condition 1125, and presence or absence of work impact 1126. Each entry in the work impact management table 112 corresponds to one inference result.

In the inference result ID 1121 among the items, an inference result identifier (hereinafter referred to as “inference result ID”) is set. The model improvement system 1 manages (stores) the inference result ID in association with the input matrix ID. In the inference result 1122, information indicating an inference result is set. For example, if the inference model is the model that estimates the time required for the vehicle to arrive at the destination in the vehicle allocation system, in the inference result 1122, for example, “estimated time required” is set. In the actual result 1123, the actual result is set. For example, if the inference model is the vehicle allocation system, in the actual result 1123, for example, an actual “required arrival time” is set. In the model ID 1124, an identifier of the inference model that infers the inference result (hereinafter referred to as “model ID”) is set. In the work impact determination condition 1125, information indicating a work impact determination condition, which is a condition used to determine the degree of the impact on the work of the inference result, is set. For example, if the inference model is the vehicle allocation system, the work impact determination condition is, for example, “whether or not the vehicle arrives in a predetermined time (KPI)”. In the presence or absence of work impact 1126, information indicating a result of determining whether or not the inference result has an impact on the work and a degree of the impact on the work (for example, the “SEVERE”, “YES”, “NO”, and the like) by applying the work impact determination condition to the inference result and the actual result is set.

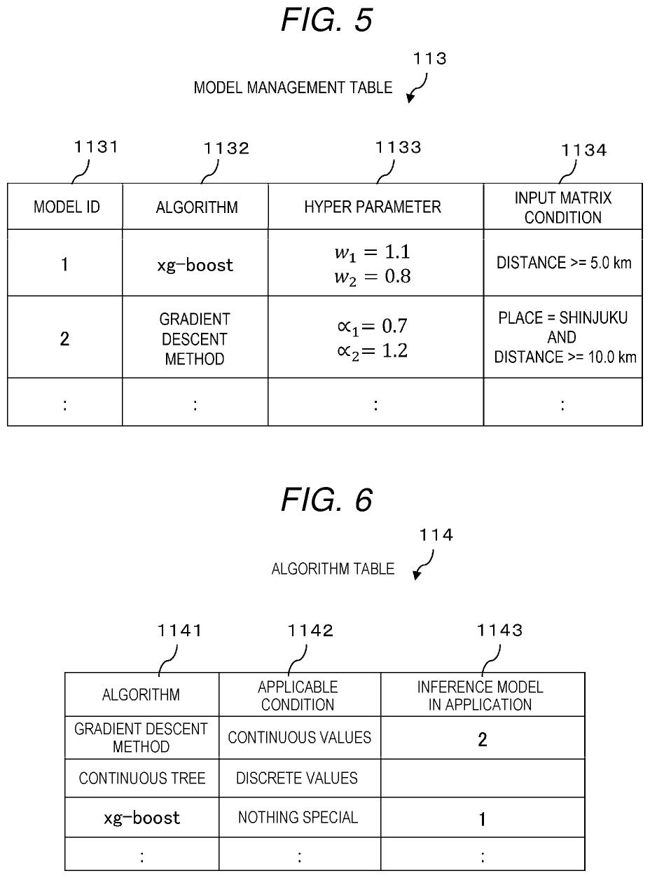

FIG. 5 shows an example of the model management table 113. In the model management table 113, information related to the inference model is managed. The inference model is implemented by, for example, a program written using a programming language (Python (registered trademark), and the like) rich in libraries for machine learning. The model management table 113 is set, for example, by the user via the user interface. Contents in the model management table 113 are updated at any time by the model rebuilding unit 163. As shown in FIG. 5, the illustrated model management table 113 includes one or more entries (records) including each item of a model ID 1131, an algorithm 1132, a hyper parameter 1133, and an input matrix condition 1134. Each entry in the model management table 113 corresponds to one inference model.

In the model ID 1131 among the items, a model ID is set. In the algorithm 1132, information related to the algorithm that constitutes the inference model (corresponding to an algorithm in the algorithm table 114) is set. In the hyper parameter 1133, hyper parameters (weighting factors in the algorithm applied to the inference model, parameters used for regularization, a depth of a decision tree, and the like) are set. In the input matrix condition 1134, a condition about the input matrix of the inference model used when the model selection unit 130 selects an inference model described later is set.

FIG. 6 shows an example of the algorithm table 114. Information related to an algorithm (logic) used when the model rebuilding unit 163 rebuilds the inference model and the like is managed in the algorithm table 114. The algorithm table 114 is set, for example, by the user via the user interface. As shown in FIG. 6, the illustrated algorithm table 114 includes one or more entries (records) including each item of an algorithm 1141, an applicable condition 1142, and an inference model in application 1143. Each entry of the algorithm table 114 corresponds to one algorithm.

In the algorithm 1141 among the items, information related to the algorithm used in the inference model is set. In the applicable condition 1142, a condition imposed on the feature amount in the input matrix of the inference model when the model rebuilding unit 163 searches for a newly applied inference model is set. For example, when “continuous values” is described in the applicable condition 1142, if the feature amount of the input matrix includes discrete values, the model rebuilding unit 163 does not use the algorithm for rebuilding the inference model. In the inference model in application 1143, a model ID of the inference model rebuilt using the algorithm is set.

### Processing Outline

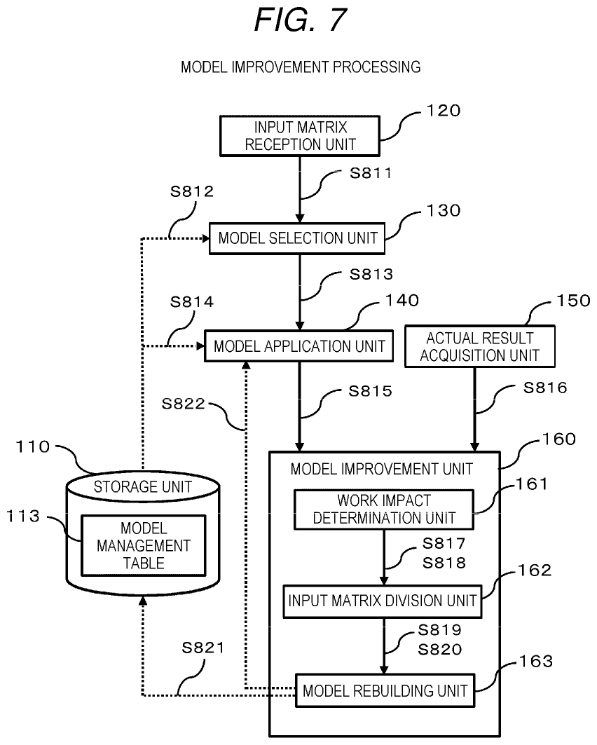

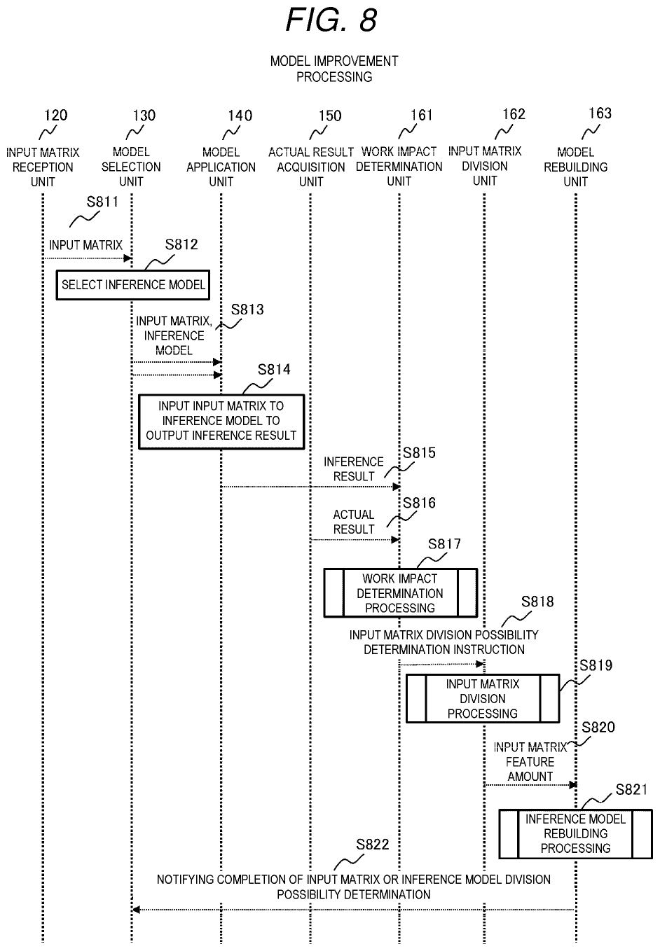

FIG. 7 is a system flow chart illustrating an outline of processing (hereinafter referred to as “model improvement processing”) performed by the main functions of the model improvement system 1, and FIG. 8 is a sequence diagram illustrating the model improvement processing. The main functions of the model improvement system 1 will be described together with these drawings.

First, the input matrix reception unit 120 inputs an input matrix received from the outside to the model selection unit 130 (S811).

Next, the model selection unit 130 selects an inference model from the model management table 113 (S812). Specifically, the model selection unit 130 specifies from the model management table 113 those satisfying conditions for the input matrix (for example, the input matrix condition 1134 in the model management table 113, which will be described later), and acquires the algorithm 1132 and the hyper parameter 1133 of the specified inference model from the model management table 113.

Next, the model selection unit 130 transmits the input matrix and the selected inference model to the model application unit 140 (S813).

When the model application unit 140 receives the inference model sent from the model selection unit 130, the input matrix is input to the received inference model (S814), and then an inference result output by the inference model is input to the work impact determination unit 161 of the model improvement unit 160 (S815). In this case, the model application unit 140 may present the inference result to the user.

The actual result acquisition unit 150 receives an actual result corresponding to the inference result of the inference model from the outside, and inputs the received actual result to the work impact determination unit 161 of the model improvement unit 160 (S816).

The work impact determination unit 161 performs processing of determining an impact on work of the inference result based on the inference result input from the model application unit 140 and the actual result input from the actual result acquisition unit 150 (hereinafter referred to as “work impact determination processing S817”). Then, if the work impact determination unit 161 determines that the inference result affects the work by the work impact determination processing S817, a division possibility determination instruction, which is an instruction for determining whether or not the input matrix that generates the inference result (the input matrix input for the inference result) can be separated (divided) from other input matrices, is input to the input matrix division unit 162 (S818).

When the division possibility determination instruction is input to the input matrix division unit 162, the input matrix division unit 162 determines whether or not the input matrix can be divided based on a determination result of the work impact determination unit 161 (Hereinafter, this processing is referred to as “input matrix division processing S819”.), and if it is determined that the input matrix can be divided, the input matrix is divided, and an input matrix that generates the inference result that affects the work among the divided input matrix is input to the model rebuilding unit 163 (S820).

When the input matrix is input to the model rebuilding unit 163, the model rebuilding unit 163 rebuilds (generates) an inference model applied to the input matrix (Hereinafter, this processing is referred to as “inference model rebuilding processing S821”.), and reflects a rebuilt result in the model management table 113 (S821).

Then, if it is determined that the inference result affects the work in the work impact determination processing S817, the model rebuilding unit 163 notifies the model selection unit 130 of the input matrix that generates the inference result that affects the work, and if it is determined that the inference result does not affect the work in the work impact determination processing S817, the model rebuilding unit 163 notifies the model selection unit 130 that the determination of whether or not the input matrix can be divided is completed (S822).

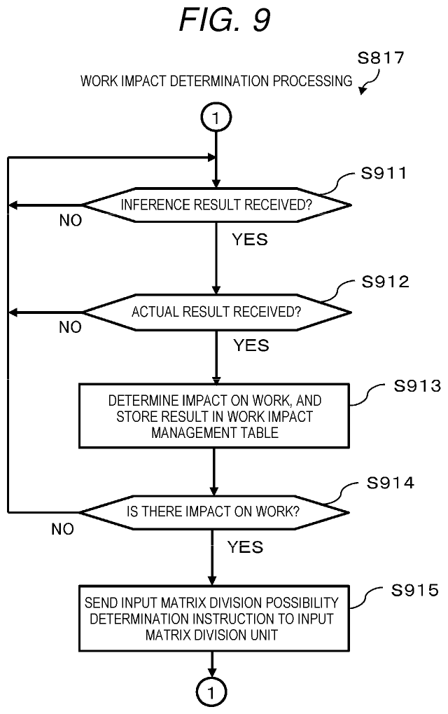

FIG. 9 is a flowchart illustrating details of the work impact determination processing S817 shown in FIG. 8. Hereinafter, the work impact determination processing S817 will be described together with FIG. 9.

The work impact determination unit 161 waits for reception of the inference result of the inference model from the model application unit 140 (S911: NO). If the work impact determination unit 161 receives the inference result from the model application unit 140 (S911: YES), the processing proceeds to S912.

In S912, the work impact determination unit 161 waits for reception of the actual result corresponding to the inference result from the actual result acquisition unit 150 (S912: NO). If the work impact determination unit 161 receives the actual result from the actual result acquisition unit 150 (S912: YES), the processing proceeds to S913.

In S913, the work impact determination unit 161 determines the impact on the work based on the received inference result and the actual result, and reflects a determined result in the work impact management table 112.

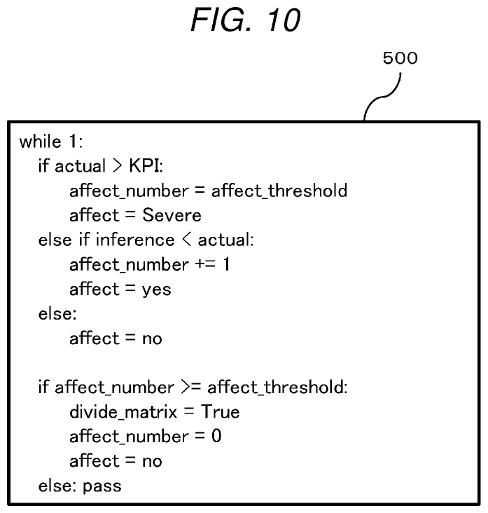

FIG. 10 shows an example of a source code (a source code written in Python (registered trademark)) of a program that implements the determination processing. If the actual result (actual) does not satisfy the KPI (actual>KPI), the illustrated source code determines that the impact on the work is “SEVERE” (affect=Severe). If the actual result (actual) satisfies the KPI (KPI), but the actual result (actual) is larger than the inference result (inference) (away from the KPI) (inference<actual), the illustrated source code determines that the impact on the work is “YES” (affect=yes). The illustrated source code counts the number (affect_number) of times the actual result (actual) is larger than the inference result (inference) (affect_number+=1), and if the number is equal to or larger than a preset threshold (affect_number>=affect_threshold), the illustrated source code determines that the input matrix can be divided (divide_matrix=True). Returning to FIG. 9, the work impact determination unit 161 then branches the processing according to a determination result of S913 (S914). If it is determined in S913 that there is an impact on the work (S914: YES), the processing proceeds to S915. If it is determined in S913 that there is no impact on the work (S914: NO), the processing returns to S911, and the work impact determination unit 161 waits for reception of a new inference result. In this case, the work impact determination unit 161 may present the determination result to the user.

In S915, the work impact determination unit 161 inputs the division possibility determination instruction of the input matrix to the input matrix division unit 162. Then, the processing returns to S911, and the work impact determination unit 161 waits for reception of a new inference result. The work impact determination unit 161 may present the inference result, the actual result, the determination result in S913, and the like to the user, and receive a manifestation of intention from the user as to whether or not to determine whether or not the input matrix can be divided, so as to control whether or not to input the division possibility determination instruction according to the manifestation of intention of the user.

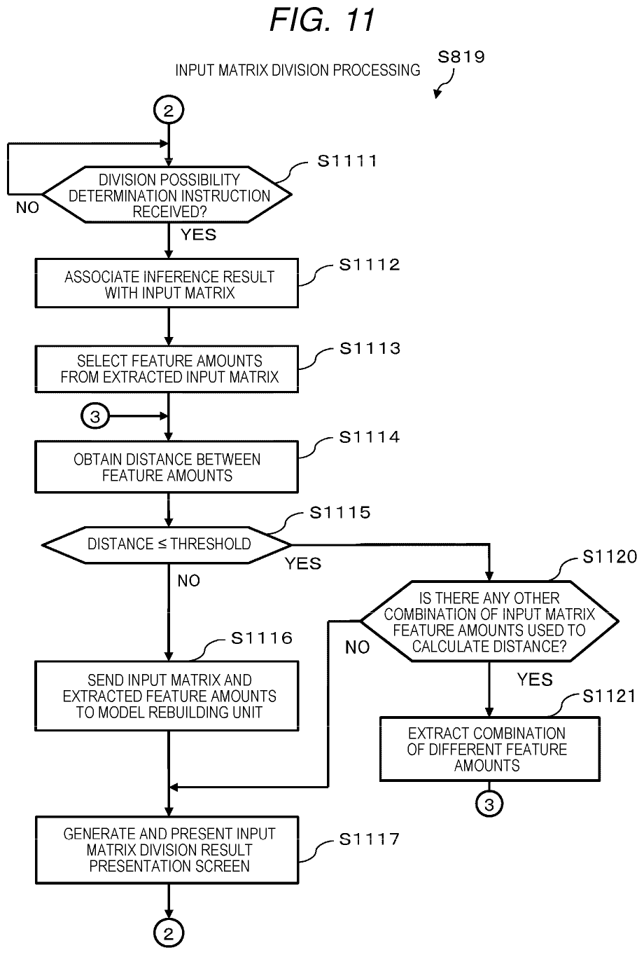

FIG. 11 is a flowchart illustrating details of the input matrix division processing S819 shown in FIG. 8. Hereinafter, the input matrix division processing S819 will be described with reference to FIG. 11.

The input matrix division unit 162 waits for reception of the division possibility determination instruction of the input matrix from the work impact determination unit 161 (S1111: NO). If a division instruction of the input matrix is received (S1111: YES), the processing proceeds to S1112.

In S1112, the input matrix division unit 162 extracts the input matrix corresponding to the inference result from the input matrix table 111 and associates the input matrix with the inference result (S1112). For example, the input matrix to be extracted may be an input matrix in an entire range up to a time when the division instruction is given, or may be an input matrix that matches a predetermined condition. The condition is, for example, that the content in the presence or absence of work impact 1117 of the input matrix table 111 is a predetermined content (“SEVERE”, “YES”). The condition is, for example, after a time when an event in the source code 500 shown in FIG. 10 in which the number of times that there is an impact on the work exceeds a threshold. The association between the input matrix and the inference result is performed, for example, by associating the input matrix ID with the inference result ID.

Next, the input matrix division unit 162 verifies whether or not the inference result that affects the work and the inference result that does not affect the work can be divided for a predetermined number of feature amounts selected from the feature amounts included in the input matrix.

Specifically, the input matrix division unit 162 selects the feature amounts from an extracted input matrix (S1113), and obtains a distance between different entries of the extracted input matrix for the selected feature amounts (S1114). The feature amounts are selected by a well-known method such as a “filter method” or a “wrapper method.” For example, when two feature amounts (a first feature and a second feature) are selected, the distance is a Mahalanobis distance or a Euclidean distance when the first feature amount is set as an x-axis and the second feature amount is set as a y-axis.

Next, the input matrix division unit 162 determines whether or not the distance obtained in S1114 is equal to or less than the preset threshold (S1115). If the input matrix division unit 162 determines that the distance is equal to or less than the threshold (S1115: YES), the processing proceeds to S1120. However, if the input matrix division unit 162 determines that the distance exceeds the threshold (S1115: NO), the processing proceeds to S1116.

In S1120, the input matrix division unit 162 determines whether or not there is a feature amount different from the feature amount used when the distance is obtained in S1114. If the input matrix division unit 162 determines that there is a different feature amount (S1120: YES), the processing proceeds to S1121. If the input matrix division unit 162 determines that there is no different feature amount (S1120: NO), the processing proceeds to S1117.

In S1121, the input matrix division unit 162 extracts a feature amount different from the feature amount used for calculating the distance in S1114 (in a loop processing so far) from the input matrix table 111, and then the processing returns to S1114.

In S1116, the input matrix division unit 162 transmits the input matrix and the extracted feature amount to the model rebuilding unit 163.

In S1117, the input matrix division unit 162 generates the input matrix division result presentation screen 1400, which will be described later, and presents the above results to the user. Specifically, if a combination of feature amounts whose distance exceeds the threshold can be extracted, the input matrix division unit 162 presents to the user that the input matrix can be divided and a division result based on the combination of the extracted feature amounts, and if a combination of feature amounts whose distance exceeds the threshold cannot be extracted, the input matrix division unit 162 presents to the user that the input matrix cannot be divided. When the combination of the feature amounts whose distance exceeds the threshold cannot be extracted, the input matrix division unit 162 may present to the user, for example, information for prompting relearning about the current inference model.

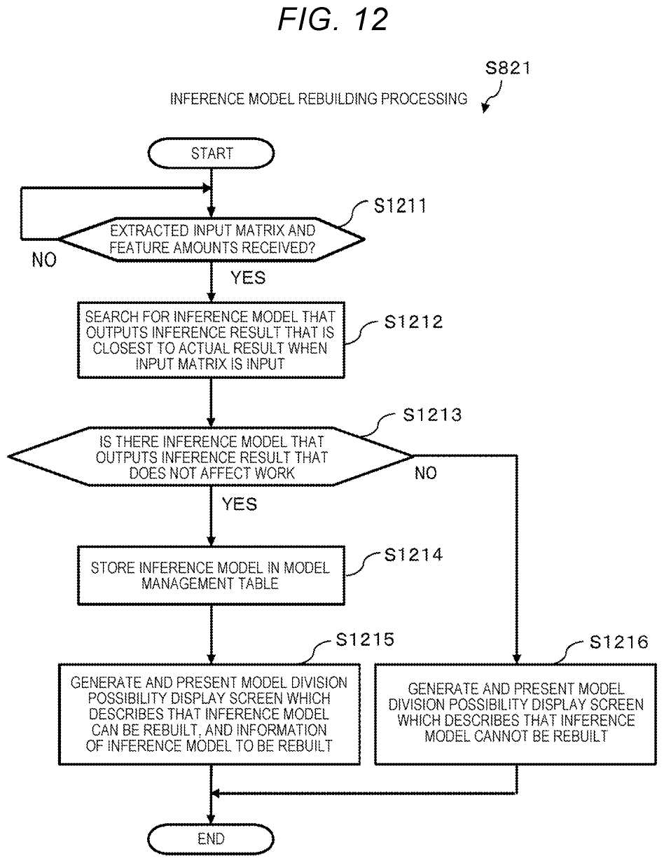

FIG. 12 is a flowchart illustrating details of the inference model rebuilding processing S821 shown in FIG. 8. In the inference model rebuilding processing S821, the model rebuilding unit 163 generates an inference model that gives an inference result that does not affect the work for the input matrix received from the input matrix division unit 162. The inference model can be generated by using, for example, Function as a Service (FaaS) or a cloud-based inference model learning processing automation service. Hereinafter, the inference model rebuilding processing S821 will be described with reference to FIG. 12.

The model rebuilding unit 163 waits for reception of the input matrix and the feature amount extracted by the input matrix division unit 162 (S1211: NO). When the model rebuilding unit 163 receives the extracted input matrix and the extracted feature amount (S1211: YES), the processing proceeds to S1212.

In S1212, the model rebuilding unit 163 applies the input matrix extracted by the input matrix division unit 162 to an inference model built by using a plurality of algorithms in the algorithm table 114 and hyper parameters, and compares an inference result obtained thereby with an actual result corresponding to the inference result, so as to search for an inference model that outputs an inference result that is closest to the actual result. The model rebuilding unit 163 narrows down candidates of the algorithms by, for example, referring to the applicable condition 1142 of the algorithm table 114. For example, the model rebuilding unit 163 searches for the hyper parameters of the algorithm in use, and then searches for the algorithm to be used in the algorithm table 114. Examples of hyper parameter search methods include grid search and Bayesian optimization.

Next, the model rebuilding unit 163 determines whether or not there is an inference model that outputs an inference result that does not affect the work in the searched inference models (S1213). If there is an inference model that outputs an inference result that does not affect the work (S1213: YES), the processing proceeds to S1214. If there is no inference model that outputs an inference result that does not affect the work (S1213: NO), the processing proceeds to S1216. In this case, the model rebuilding unit 163 may determine an inference model that gives the least number of inference results that affect the work or an inference model that gives an inference result that is closest to the actual result as the inference model that outputs an inference result that does not affect the work. The model rebuilding unit 163 may present to the user a result of difference obtained by comparing the inference result and the actual result for each of the inference models found in S1212, and accept a selection of the inference model from the user.

In S1214, the model rebuilding unit 163 stores the inference model determined to output an inference result that does not affect the work in the model management table 113.

In S1215, the model rebuilding unit 163 generates a model rebuilding possibility information presentation screen 1500 described later, which describes that the inference model can be rebuilt, and information of the inference model stored in S1214, and presents the generated model rebuilding possibility information presentation screen 1500 to the user.

In S1216, the model rebuilding unit 163 generates the model rebuilding possibility information presentation screen 1500 described later, which describes that the inference model cannot be rebuilt, and presents the generated model rebuilding possibility information presentation screen 1500 to the user.

### Examples of Screens

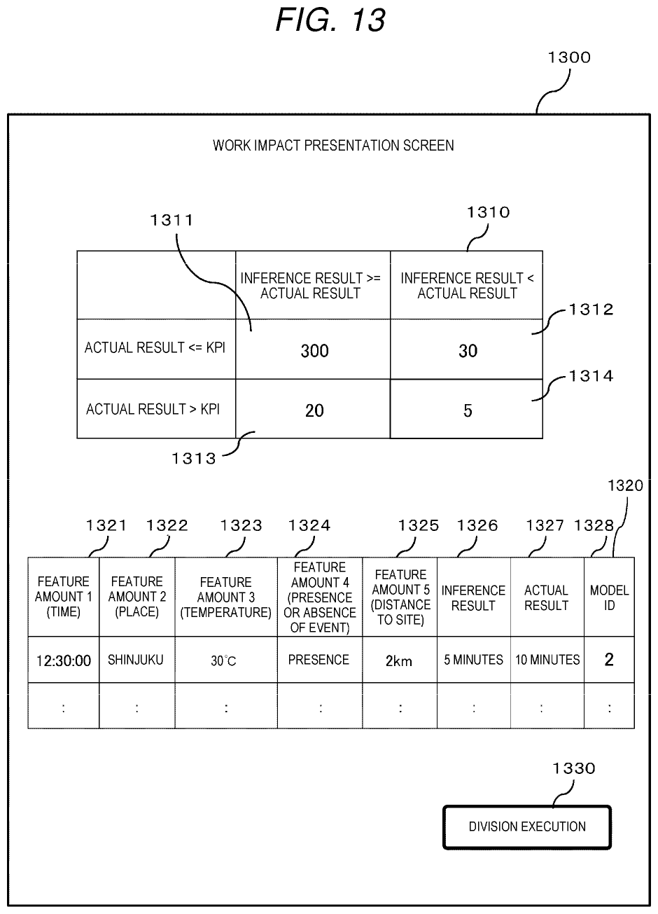

FIG. 13 is an example of a screen (Hereinafter, it is referred to as “work impact presentation screen 1300”.) displayed when the information presentation unit 170 presents to the user information related to an impact on the work of an inference result. As shown in FIG. 13, the work impact presentation screen 1300 includes a work impact display column 1310, an inference model information display column 1320, and a division execution button 1330. The work impact presentation screen 1300 shown in FIG. 13 illustrates a case where the inference model is the model for inferring the time required for the vehicle to arrive at the destination in the vehicle allocation system. By referring to the work impact presentation screen 1300, the user can easily confirm the information related to the impact on the work of the inference result.

In the work impact display column 1310, information indicating the impact on the work of the inference result obtained by the inference model is displayed. In the illustrated work impact presentation screen 1300, the impact on the work of the inference result is classified and displayed in four combinations of magnitude relations between the inference result and the actual result (horizontal axis) and magnitude relations between the actual result and the KPI (allowable arrival time) (vertical axis). Specifically, the work impact display column 1310 displays that among the input matrixes extracted by the input matrix division unit 162, there are 300 cases (numeral 1311) where an actual arrival time is earlier than an inferred arrival time and the actual arrival time satisfies the KPI; there are 30 cases (numeral 1312) where the actual arrival time is later than the inferred arrival time but the actual arrival time satisfies the KPI; there are 20 cases (numeral 1313) where the actual arrival time is earlier than the inferred arrival time but the actual arrival time does not satisfy the KPI; and there are 5 cases (numeral 1314) where the actual arrival time is later than the inference arrival time and the actual arrival time does not satisfy the KPI.

In the illustrated work impact presentation screen 1300, for example, the cases of numeral 1314, that is, the “case where the actual arrival time is later than the inference arrival time and the actual arrival time does not satisfy the KPI” may be highlighted as a case where the impact on the work of the inference result is severe. The cases of numeral 1313, that is, the “case where the actual arrival time is earlier than the inferred arrival time but the actual arrival time does not satisfy the KPI” may be highlighted as a case where there is an impact on the work of the inference result.

In the inference model information display column 1320, information related to the inference model that outputs the inference result (feature amounts 1321 to 1325, an inference result 1326, an actual result 1327, and a model ID 1328) is displayed. Therefore, the user can easily confirm the information related to the inference model.

The division execution button 1330 is operated when the user instructs division of the input matrix and rebuilding of the inference model. When the model improvement unit 160 detects that the division execution button 1330 is operated, the model improvement unit 160 executes the processing described above such as determining whether or not the input matrix can be divided, dividing the input matrix, and reconstructing the inference model.

For example, the information stored in the storage unit 110 (all or a part of the contents in at least one of the input matrix table 111, the work impact management table 112, the model management table 113, and the algorithm table 114, a KPI value, and the like) may be further displayed on the work impact presentation screen 1300. For example, the work impact presentation screen 1300 may be provided with the user interface (a reception screen or an operation button) for receiving input of various kinds of information from the user in the various processing.

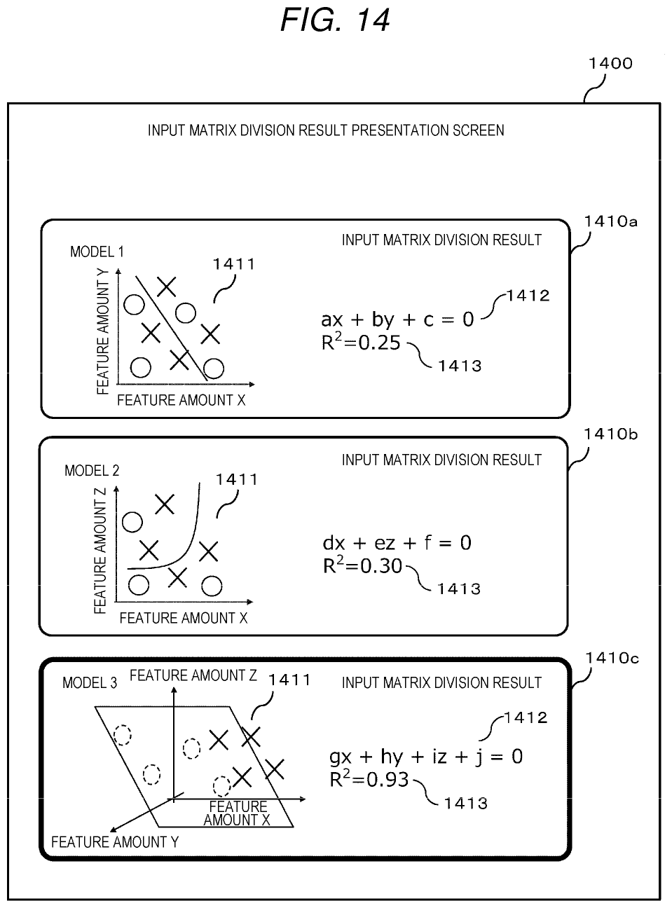

FIG. 14 is an example of a screen (Hereinafter, it is referred to as “input matrix division result presentation screen 1400”.) displayed when the information presentation unit 170 presents information related to the division result of the input matrix determined by the input matrix division unit 162 to the user. As shown in FIG. 14, the input matrix division result presentation screen 1400 includes one or more input matrix division result display columns 1410 (in this example, three input matrix division result display columns 1410 indicated by numerals 1410a to 1410c). The user can confirm the information related to the division result of the input matrix determined by the input matrix division unit 162 by referring to the input matrix division result presentation screen 1400.

The input matrix division result display column 1410 displays a graph (numeral 1411) showing distribution of the feature amounts of the input matrix extracted by the input matrix division unit 162, a machine learning model (numeral 1412) verified when determining a machine learning model used to divide the input matrix, and an index showing the distance of feature amounts between the entries (numeral 1413). In this example, a coefficient of determination obtained by normalizing a prediction miscalculation of the machine learning model is used as the index. In the illustrated input matrix division result presentation screen 1400, the input matrix division result display column 1410 corresponding to each verified machine learning model is displayed. In the graph (numeral 1411) showing the distribution of the feature amounts of the input matrix, a “circle mark” indicates an inference result that does not affect the work, and a “cross mark” indicates an inference result that affects the work.

In this example, since a distance of the input matrix division result display column 1410c is the farthest (R²=0.93), a frame of the input matrix division result display column 1410c is highlighted by a thick line. In this case, the input matrix division unit 162 selects a feature amount x, a feature amount y, and a feature amount z as the feature amounts. Selection of one of the displayed input matrix division result display columns 1410 may be received from the user, and the feature amounts used in the graph 1411 of the received input matrix division result display column 1410 may be selected by the input matrix division unit 162.

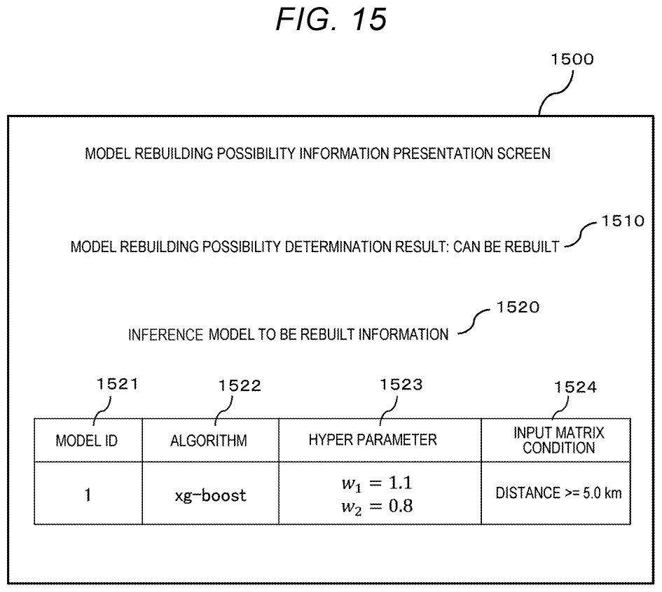

FIG. 15 is an example of a screen (Hereinafter, it is referred to as “model rebuilding possibility information presentation screen 1500”.) displayed when the information presenting unit 170 presents to the user information indicating that the inference model can be rebuilt and information related to the inference model to be rebuilt. As shown in FIG. 15, the model rebuilding possibility information presentation screen 1500 includes a model rebuilding possibility determination result display column 1510 and an inference model to be rebuilt information display column 1520. The user can easily confirm that the inference model can be rebuilt and the information related to the inference model to be rebuilt by referring to the model rebuilding possibility information presentation screen 1500.

In the model rebuilding possibility determination result display column 1510, a determination result of whether or not the inference model can be rebuilt is displayed, and if the inference model can be rebuilt, “can be rebuilt” is displayed, and if the inference model cannot be rebuilt, “cannot be rebuilt” is displayed.

In the inference model to be rebuilt information display column 1520, if the inference model can be rebuilt, the information related to the inference model to be rebuilt (in this example, a model ID 1521, an algorithm 1522, a hyper parameter 1523, and a condition imposed on input matrix 1524) is displayed.

As described above, the model improvement system 1 of the present embodiment divides a part of the input matrix that outputs an inference result that affects the work from the input matrix, and generates an inference model that outputs an inference result that does not affect the work when the part divided from the input matrix is input as an input matrix. The user does not need to verify that the service level agreement (SLA) is not impaired for the model that outputs the inference result that does not affect the work among the existing inference models. Therefore, according to the model improvement system 1 of the present embodiment, it is possible to efficiently and appropriately improve the inference model when the inference model outputs the inappropriate inference result that affects the work.

Although one embodiment of the invention is described above, it goes without saying that the invention is not limited to the embodiment and can be variously modified without departing from a gist thereof. For example, the embodiment is described in detail for easy understanding of the invention, and the invention is not necessarily limited to those including all the configurations described above. Other configurations can be added to, eliminated from, or replaced with a part of the configurations of the embodiment.

A part of or all of the configurations, functional units, processing units, processing methods, and the like may be implemented by hardware obtained by, for example, designing an integrated circuit. The configurations, functions, and the like may also be implemented by software by a processor interpreting and executing a program that implements each function. Information of a program, a table, a file, and the like for realizing each function can be placed in a recording device such as a memory, a hard disk, or a solid state drive (SSD), or in a recording medium such as an IC card, an SD card, or a DVD.

Arrangement forms of various functional units, various processing units, and various databases of the various information processing devices, which are described above are merely examples. The arrangement forms of the various functional units, the various processing units, and the various databases can be changed to an optimum arrangement form from viewpoints of performance, processing efficiency, communication efficiency, and the like of the hardware and the software that are included in the devices.

A configuration (schema and the like) of the database storing various types of data can be flexibly changed from viewpoints of efficient utilization of resources, improvement of processing efficiency, improvement of access efficiency, improvement of search efficiency, and the like.

What is claimed is:

1. A model improvement system implemented by an information processing device, the model improvement system comprising:
a model application unit configured to perform inference related to work using an inference model which is a machine learning model that outputs an inference result by inputting an input matrix;
an actual result acquisition unit configured to acquire an actual result which is information acquired by actually performing work to be inferred by the inference model;
a work impact determination unit configured to determine whether or not the inference result includes an inappropriate content that affects the work by comparing the inference result with the actual result;
an input matrix division unit configured to divide a part of the input matrix that outputs the inference result that affects the work from the input matrix; and
a model rebuilding unit configured to generate an inference model that outputs an inference result that does not affect the work when the part divided from the input matrix is input as an input matrix.

2. The model improvement system according to claim 1, wherein
the work impact determination unit is configured to, when the actual result does not satisfy a preset key performance indicator and the actual result is larger than the inference result, determine that the inference result includes an inappropriate content that affects the work.

3. The model improvement system according to claim 1, wherein
the work impact determination unit is configured to output information indicating correlations among a key performance indicator, the actual result, and the inference result.

4. The model improvement system according to claim 1, wherein
the work impact determination unit is configured to divide the input matrix when an instruction of dividing the input matrix is received from a user.

5. The model improvement system according to claim 1, wherein
the input matrix division unit is configured to specify the part by verifying whether or not the inference result that affects the work and the inference result that does not affect the work are divisible for a predetermined number of feature amounts selected from feature amounts included in the input matrix.

6. The model improvement system according to claim 1, wherein
the input matrix division unit is configured to output information for prompting relearning of the inference model when the part is not specified.

7. The model improvement system according to claim 1, wherein
the model rebuilding unit is configured to generate a plurality of candidate models that are candidates for an inference model to be rebuilt, acquire inference results output by the candidate models by inputting the part of the input matrix that outputs the inference result that affects the work, and specify a candidate model that outputs the inference result that does not affect the work as an inference model to be rebuilt when the inference result exists.

8. The model improvement system according to claim 1, wherein
the model rebuilding unit is configured to output information related to the inference model when an inference model to be rebuilt is specified.

9. A model improvement method implemented by an information processing device comprising:
performing inference related to work using an inference model which is a machine learning model that outputs an inference result by inputting an input matrix;
acquiring an actual result which is information acquired by actually performing work to be inferred by the inference model;
determining whether or not the inference result includes an inappropriate content that affects the work by comparing the inference result with the actual result;
dividing a part of the input matrix that outputs the inference result that affects the work from the input matrix; and
generating an inference model that outputs an inference result that does not affect the work when the part divided from the input matrix is input as an input matrix.

10. The model improvement method according to claim 9, further comprising:
determining that the inference result includes an inappropriate content that affects the work when the actual result does not satisfy a preset key performance indicator and the actual result is larger than the inference result.

11. The model improvement method according to claim 9, further comprising:
outputting information indicating correlations among a key performance indicator, the actual result, and the inference result.

12. The model improvement method according to claim 9, further comprising:
dividing the input matrix when an instruction of dividing the input matrix is received from a user.

13. The model improvement method according to claim 9, further comprising:
specifying the part by verifying whether or not the inference result that affects the work and the inference result that does not affect the work are divisible for a predetermined number of feature amounts selected from feature amounts included in the input matrix.

14. The model improvement method according to claim 9, further comprising:
outputting information for prompting relearning of the inference model when the part is not specified.

15. The model improvement method according to claim 9, further comprising:
generating a plurality of candidate models that are candidates for an inference model to be rebuilt, acquiring inference results output by the candidate models by inputting the part of the input matrix that outputs the inference result that affects the work, and specifying a candidate model that outputs the inference result that does not affect the work as an inference model to be rebuilt when the inference result exists.
